(19) United States
(12) Patent Application Publication
(10) Pub. No.: US 2006/0160685 A1
(43) Pub. Date: Jul. 20, 2006

(54) Paper sack bottoming device

(76) Inventor: Andreas Lamkemeyer, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/563,859

(22) PCT Filed: Jul. 6, 2004
(86) PCT No.: PCT/EP04/07489

§ 371 Date: Jan. 9, 2006

(30) Foreign Application Priority Data
Jul. 7, 2003 (DE) 103 30 751.6

(51) Int. Cl. B31B 1/62

(52) U.S. Cl. 493/150

(57) ABSTRACT

The present invention relates a to a base insert device for crossed base valve bags for the formation of crossed bases in paper bags by means of folding devices, which introduce folds at the ends of the tubular sections from which the bags are produced, with one or more gluing stations, which apply glue to the regions of the folds for gluing and/or the sheets, provided for gluing to the base, and at least one pressing station in which the folded bases and the sheets are brought into contact with one another and glued.

The special characteristic of the present invention is that at least one gluing station for the sheet and/or bases is provided, comprising glue outlet openings (17) which may be selectively supplied with glue, whereby the selection of the glue outlet openings (17) defines the format of the glue application (6, 7, 8, 9). Said glue outlet openings are provided with at least one application head (1) that supports valves (3), which can selectively open and close the connection (11, 16) between the glue outlet openings and a glue supply unit (4a, 4b, 13, 15), whereby said glue supply unit comprises glue supplying lines (4a, 4b, 13) and at least one chamber (15) through which at least one part of the valves (3) is supplied with glue and which has a diameter of at least 5 mm at least at one point.

This is a nationalization of PCT/EP04/007489 filed Jul. 6,2004 and published in German.

The present invention relates to a base insert device for paper bags in accordance with the preamble of main claim 1.

Devices of this type are used in the production of various types of bags. These bags include, for example, the so-called valve bags in which valve patches are usually inserted when manufacturing the bases of the bags. The bases are frequently designed as crossed bases as illustrated, for example in the patent applications DE 090 145 48 U1and DE 3020043 A1. In order to provide the bases and the inserted valve patches with a lasting cohesion, parts of the bases are stuck one below the other and/or to the valve patches with the help of glue.

For this purpose, glue is applied to either the regions of the base folds to be glued or the sheets provided to them, thus all the regions that are to be glued to one another and these are subsequently glued to one another by merging them or folding them together.

A format-specific glue application usually takes place in the following manner: A format part attached on a rotating roller is brought into contact during the rotation of said roller with a glue roller or with other glue storing components or transfer components and is thus supplied with glue. In the further course of the rotation of the roller, the format plate transfers the glue stored on it onto each region of the subsequently formed bases of the bags or the sheets to be glued. For this purpose, the format part is provided with characteristic ridges that are adapted to a definite bag format. The format parts are replaced for producing bags having other formats on the base insert device. This type of glue application has stood the test of time since it enables the clean and format-specific application of large quantities of starch glue, which is otherwise difficult to handle.

The words “format-specific glue application” refers to a form of application that is adapted to the type and the format of the bag. In this form of application, the glue is usually applied in a flat manner, whereby special significance is accorded to the edges of the form for the durability and the impermeability of the bags.

However, the disadvantage is that this method of glue transfer makes it necessary to provide and subsequently clean a plurality of glue transfer components, for instance the format rollers and the format parts.

Therefore the object of the present invention is to further improve the design of the base insert device in such a way that these glue transfer components can be totally omitted while still enabling a format-specific application of the glue, whereby the glue must be distributed evenly over the surface to be glued.

Said object is achieved by the characterizing features of the main claim 1.

Thus, at least one gluing station is provided in the base insert device, which
comprises glue outlet openings which may be selectively supplied with glue, whereby the selection of the glue outlet openings defines the format of the glue application (6, 7, 8, 9),
whereby said glue outlet openings are provided with at least one application head (1)
which supports valves (3) that can selectively open and close the connection between glue outlet openings and a glue supply unit (4a, 4b, 13, 15),
whereby said glue supply unit comprises glue supplying lines (4a, 4b, 13) and at least one chamber (15) through which at least one part of the valves (3) is supplied with glue and which has a diameter of at least 5 mm at least in one point.

The application head can be provided with an application plate into which said glue outlet openings that can be selectively supplied with glue, are inserted. In order to enable glue discharge when the valves are opened, the glue is exposed to a pressure that is greater than the ambient pressure. The valves are initially supplied with glue using glue supplying lines, which supply the glue to a chamber. The valves are in contact with this chamber. By providing the valves with a diameter of m mm, it can be ensured that the extremely viscous glue, usually starch glue, can flow through the chamber without clogging the chamber. The chamber can have a circular cross-section. However, the cross-section can also have a shape that differs from a circular shape. However, the cross-section must be dimensioned in such a way that a circle having a diameter of 5 mm can be inscribed so as to ensure a continuous flow of glue to all the valves.

The chamber preferably has a diameter of at least 7 mm. Only in the case of a diameter of 7 mm is it possible to ensure that essentially the same glue pressure is prevalent at all the valves. If this diameter is fallen short of, it is possible that the rear valves in the flow direction of the glue are only supplied with a low glue pressure. Consequently, the glue traces generated from these valves also can be too thin.

However, in a preferred embodiment of the present invention, the chamber has a diameter of at least 10 mm. This diameter is provided particularly if the valves are arranged very densely.

In another preferred embodiment of the present invention, the chamber is arranged in the application head or directly on the application head in order to maintain a small distance between the chamber and the valves. If pressure is applied to the glue, which as described already, can be very viscous, then the pressure rests against the valve without any substantial pressure losses when the connections from the chamber to the valve are short. This connection is usually a few millimeters long.

In another embodiment of the present invention, at least two valves are arranged such that they overlap in the spatial direction (y) perpendicular to the feed direction (x) of the bag components. The valves are supplied with glue from the same chamber. This makes it possible to achieve a denser arrangement of the valves in the spatial direction (y) and thus a greater density of glue traces, which can be applied or interrupted independently of one another. Such an arrangement of the valves comprises, in particular, a two-row or multi-row arrangement whereby the rows run the spatial direction (y) and are interspaced in the feed direction (x) of the bag components. Spatial direction (y) refers to that direction, which extends perpendicular to the feed direction (x) of the bag components, but lies in the plane that is determined by the bag components. The third spatial direction, which indeed extends perpendicular to the feed direction (x) of the bag components, however also perpendicular to the plane of the bag components, plays no role in the context of the present invention.

Furthermore, it is particularly advantageous if the volume of the chamber has a ratio of at least 1:5 to the volume sum of all the glue connections to and from the valves, which are supplied with glue from this chamber. The pressure prevailing in the chamber also rests against all the valves without any substantial pressure losses only by ensuring the existence of this factor by which the volume of the chamber is greater than the sum of the glue supplying lines. Thus it is ensured that when the valves are opened, the glue is pressed out with essentially the same pressure from all the glue outlet openings, which are supplied with glue via the chamber.

In another preferred embodiment of the present invention, the chamber is a borehole that is inserted into the application head. The application head can be provided on both its front ends with a first borehole, through which the glue is supplied to the cavity, and a second borehole, through which the glue is redischarged. The cross-sectional areas of these inlet holes and outlet holes are smaller than the cross-section of the chamber. In a preferred embodiment, the cross-section of the chamber is greater than the cross-section of the glue supplying lines by 40 mm². However, the glue supply can also be implemented by a tube that engages into the application head or a tube that penetrates through the application head. In order to enable the glue to arrive into the cavity of the application head, the tube has boreholes or openings in the region of the application head. In this arrangement, the application head can also be arranged such that it can be displaced on the tube.

Additional advantageous embodiments of the present invention are specified in the graphic description, the drawings and the remaining claims.

The individual figures illustrate:

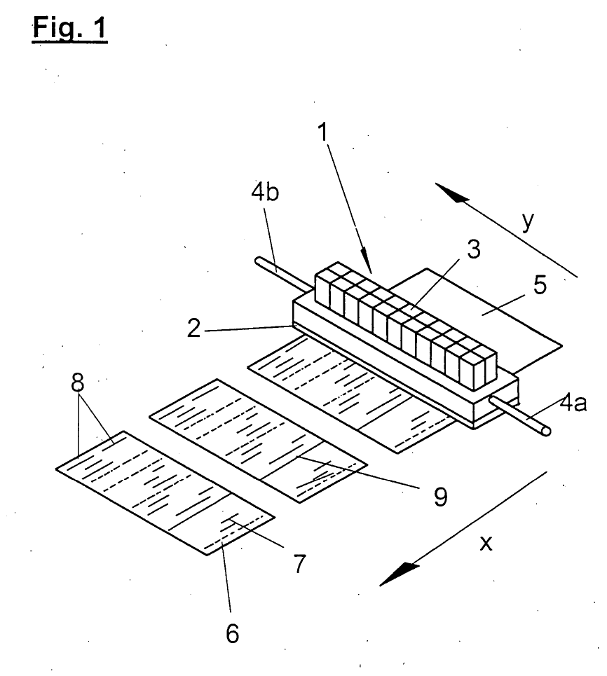

FIG. 1 an individual application head provided for the gluing station in the base insert device according to the present invention

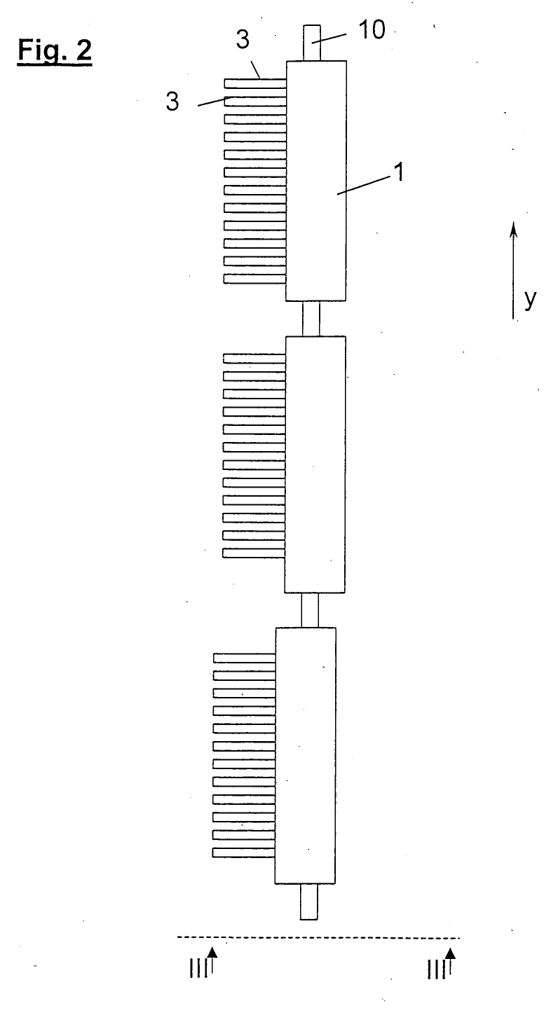

FIG. 2 an arrangement having several application heads

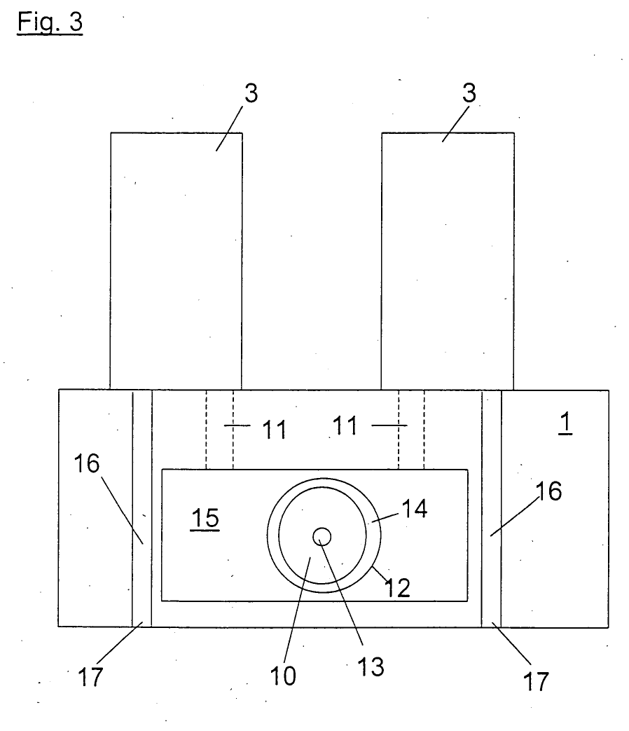

FIG. 3 frontal view of an application head

FIG. 1 illustrates an application head 1, as is used in a gluing station in the base insert device according to the present invention. This application head 1 is composed of an application plate 2, to which valves 3 are attached. The glue is supplied to the application head 1 via the glue supplying line 4a. The glue arrives out of the application head via the glue supplying line 4b. Unglued sheets 5 are supplied to the gluing station in direction x.

Every valve 3 is provided with one glue outlet opening or a group of glue outlet openings in the side of the application plate 2 that is turned towards the unglued sheets 5. The glue flow to the glue outlet opening can be produced or interrupted by the assigned valve 3. In this manner it is possible to apply on the unglued sheets 5 different glue traces that run parallel to the feed direction x of the unglued sheets 5. By regularly opening and closing the valve 3, a regularly interrupted glue trace 5 [sic; 6] can be applied. Likewise, it is possible to produce short glue traces 7 or interrupted glue traces 8 and continuous glue traces 9. If no unglued sheet 5 is located below the application head 1, then all the valves 3 interrupt the glue flow so that the gluing station is not contaminated unnecessarily. In order to be able to glue all the regions of the unglued sheets in the direction y perpendicular to the feed direction, the application head 1 can also be displaced in this direction. However, the application head just described above can be used not only for gluing sheets, but is also suitable for applying glue on the regions of the subsequently formed bases of the bags to be glued due to the variability of the glue traces that can be produced.

FIG. 2 illustrates a linear arrangement of several application heads 1, which are arranged along the tube 10 in the direction y perpendicular to the feed direction x. The tube 10 can also serve as a guide rail, along which the individual application heads 1 can be displaced relative to one another. Rows of valves 3 are attached to each of the application heads 1.

FIG. 3 illustrates a frontal view of an application head 1 according to the section III-III from FIG. 2. The application head 1 is equipped with two parallel rows of valves 3, whereby the valves 3 can also be arranged such that they can be displaced in the direction y (not visible). In order to be able to supply these valves 3 with glue, glue connections 11 to the valves 3 are inserted into the application head 1. Said glue connections begin in the chamber 15. The chamber 15 is supplied with glue by the glue supplying line 13 and by boreholes (not visible) in the tube 10 that connect the glue supplying line 13 to the chamber 15. In order to be able to seal the chamber 15 from the exterior of the application head 1, a sealing 14 that clasps around the tube 10 is inserted into the front-sided borehole 12. In order to let the glue reach the glue outlet openings 17 from the valves 3, the application head has an additional glue connection 16.

List of Reference Symbols

| | |
|---|---|
| 1 | Application head |
| 2 | Application plate |
| 3 | Valve |
| 4a, 4b | Glue supplying line |
| 5 | Unglued sheet |
| 6 | Regularly interrupted glue trace |
| 7 | Short glue trace |
| 8 | Interrupted glue trace |
| 9 | Continuous glue trace |
| 10 | Tube |
| 11 | Glue connection to the valve 3 |
| 12 | Front-sided borehole |
| 13 | Glue supplying line |
| 14 | Sealing |
| 15 | Chamber |
| 16 | Glue connection |
| 17 | Glue outlet opening |
| x | Feed direction of the sheets |
| y | Direction perpendicular to the feed direction x of the sheets |

1. Bottomer for cross bottom valve sacks for making cross bottoms on paper bags, which exhibit the following features:
Folding devices, which make folds at the ends of the tube sections, from which the bags are produced
one or more gluing stations, which provide glue spread to the areas of the folds to be glued and/or the labels provided with the bottom for gluing,
at least one press compaction deck, in which the folded bottoms and the labels are brought in contact with each other and glued, characterized in that
at least one glue deck is provided for the labels and/or bottoms, which glue deck is equipped with glue outlets, which can be fed selectively, whereby, through the selection of the glue outlets, the format of the glue spread (6,7,8,9) can be defined
these glue outlets are assigned to at least one application head (1), on which application head (1) a valve (3) is mounted, which can selectively open and shut the connection between the glue outlets and a glue feed (4a, 4b, 13),
the glue feed comprises at least one chamber (15), through which at least one part of the valves (3) is fed with the glue and which has a diameter of at least 5 mm in at least one place,
and the glue feed comprises at least one pipeline (10), which reaches through up to the application head.

2. Base insert device pursuant to the preceding claim characterized in that this chamber (5) has a diameter of at least 7 mm.

3. Base insert device pursuant to the preceding claim characterized in that this chamber (15) has a diameter of at least 10 mm.

4. Base insert device pursuant to the preceding claim characterized in that this chamber (15) has a diameter of at least 15 mm.

5. Base insert device pursuant to claim 1 characterized in that this chamber (15) is arranged in the application head (1) or directly on the application head (1).

6. Base insert device pursuant to claim 1 characterized in that this chamber (15) runs linearly in the spatial direction (y) perpendicular to the transport direction of the bag components (x).

7. Base insert device pursuant to claim 1 characterized in that at least two of the valves (3), which are supplied with glue from the same chamber (15) are arranged in an overlapping manner when seen in the spatial direction (y), which extends perpendicular to the feed direction (x) of the bag components.

8. Base insert device pursuant to claim 1 characterized in that the sum of the measures of the valves (3) in the spatial direction (y) perpendicular to the feed direction (x) is larger than the length of the chamber (15) in the spatial direction (y) perpendicular to the feed direction (x), whereby all the valves (3) are supplied with glue from this chamber (15).

9. Base insert device pursuant to claim 1 characterized in that the volume of the chamber (15) has a ratio of at least 1.5 to the volume sum of all the glue connections (11, 16) to and from the valves (3), which are supplied with glue from this chamber.

10. Base insert device pursuant to claim 1 characterized in that the gluing station comprises several chambers (15) whereby every chamber (15) supplies one part of the valves (3) in each case with glue.

11. Base insert device pursuant to claim 1 characterized in that the chamber (15) has a rectangular cross-section.

12. Base insert device pursuant to claim 1 characterized in that the chamber (15) has a circular cross-section.

13. Base insert device pursuant to the preceding claim characterized in that the chamber (15) is a borehole that is inserted into the application head.

14. Base insert device pursuant to claim 1 characterized in that at least one glue supplying line (4a, 13) via which glue is supplied to the chamber (15) engages into the chamber (15).

15. Base insert device pursuant to the preceding claim characterized in that the chamber (15) can be displaced along the glue supplying line (4a, 13) at least partly in the direction (y) extending perpendicular to the transport direction (x) of the bag components.

16. Base insert device pursuant to claim 1 characterized in that the glue supplying line (4a, 13) has a cross-sectional area, which is smaller than that of the chamber (15).

17. Base insert device pursuant to the preceding claim characterized in that the glue supplying line has a cross-sectional area, which is smaller than that of the chamber by at least 40 mm^{2.}
